(19) United States
(12) Patent Application Publication
(10) Pub. No.: US 2020/0167403 A1
(43) Pub. Date: May 28, 2020

(54) METHOD FOR DETERMINING PERFORMANCE UTILIZATION OF DEVICE AND STORAGE MEDIUM

(71) Applicants: CHONGQING BOE OPTOELECTRONICS TECHNOLOGY CO., LTD., Chongqing (CN); BOE TECHNOLOGY GROUP CO., LTD., Beijing (CN)

(72) Inventors: Min QUAN, Beijing (CN); Sung Hwan YOON, Beijing (CN); Junshan XIANG, Beijing (CN); Hu LI, Beijing (CN)

(21) Appl. No.: 16/426,535

(22) Filed: May 30, 2019

(30) Foreign Application Priority Data
Nov. 22, 2018 (CN) 201811397515.4

(51) Int. Cl. G06F 17/11

(52) U.S. Cl. CPC G06F 17/11

(57) ABSTRACT

A method for determining performance utilization of a device and a storage medium. The method includes: for N continuous sub periods of time within a continuous period of time, determining an average tact time of the device within each of the sub periods of time; taking a shortest average tact time of the device within the N sub periods of time as a performance tact time of the device within the period of time; determining an actual tact time of the device within the period of time according to an utilizable time of the device and a quantity of products actually outputted by the device within the period of time; and determining a performance utilization of the device within the period of time according to the performance tact time and the actual tact time of the device within the period of time.

### CROSS-REFERENCE TO RELATED APPLICATION

The present application claims priority to the Chinese patent application No. 201811397515.4, filed on Nov. 22, 2018, the entire disclosure of which is incorporated herein by reference as part of the present application.

### TECHNICAL FIELD

Embodiments of the present disclosure relate to a method for determining a performance utilization of a device and a storage medium.

### BACKGROUND

In a process of product production, an ability to accurately measure a production capacity of a device has a very important guiding significance for actual production. The existing overall equipment effectiveness (OEE) is determined by time utilization, performance utilization and yield rate.

### SUMMARY

At least one embodiment according to the present disclosure provides a method of determining a performance rate of a device. The method includes: for N continuous sub periods of time within a continuous period of time, determining an average tact time of the device within each of the sub periods of time, where N is an integer greater than 0; taking a shortest average tact time of the device within the N sub periods of time as a performance tact time of the device within the period of time; determining an actual tact time of the device within the period of time according to an utilizable time of the device and a quantity of products actually outputted by the device within the period of time; and determining a performance utilization of the device within the period of time according to the performance tact time and the actual tact time of the device within the period of time.

For example, in the method according to embodiments of the present disclosure, for the N continuous sub periods of time within the continuous period of time, determining the average tact time of the device within the each of the sub periods of time may include: taking an average value of an interval time between every two products outputted by the device within the each of the sub periods of time as the average tact time of the device within the each of the sub periods of time.

For example, in the method according to embodiments of the present disclosure, for the N continuous sub periods of time within the continuous period of time, determining the average tact time of the device within the each of the sub periods of time may include: for N continuous sub periods of time within a continuous period of time, determining an average tact time of the device within the each of the sub periods of time according to a time parameter of producing products by the device and a quantity of products outputted by the device within the each of the sub periods of time.

For example, in the method according to embodiments of the present disclosure, determining the average tact time of the device within the each of the sub periods of time according to the time parameter of producing the products by the device and the quantity of products outputted by the device within the each of the sub periods of time may include: taking a ratio of a normal operation time of the device to the quantity of products outputted by the device within the each of the sub periods of time as the average tact time of the device within the each of the sub periods of time.

For example, in the method according to embodiments of the present disclosure, the device is configured to produce at least two types of products, and determining the average tact time of the device within the each of the sub periods of time according to the time parameter of producing the products by the device and the quantity of products outputted by the device within the each of the sub periods of time may include: for each type of product, determining the average tact time of the device within respective sub periods of time corresponding to the product according to the time parameter of producing the products by the device and the quantity of products outputted by the device within respective sub periods of time corresponding to the product, and taking the shortest average tact time of the device within the N sub periods of time as the performance tact time of the device within the period of time may include: for each type of product, determining the shortest average tact time of the device within respective sub periods of time corresponding to the product, and taking a weighted average value of shortest average tact times of the device corresponding to various types of products as the performance tact time of the device within the period of time.

For example, in the method according to embodiments of the present disclosure, the performance tact time is determined according to the following equation:

$$T = \frac{Σ Tm * Mm}{Σ Mm} ,$$

where T represents the performance tact time of the device within the period of time, Tm represents the shortest average tact time within respective sub periods of time corresponding to m-th type of products produced by the device, and Mm represents a quantity of the m-th type of products outputted by the device within the period of time.

For example, in the method according to embodiments of the present disclosure, the actual tact time is determined according to the following equation:

$$A = \frac{U}{M} ,$$

where A represents the actual tact time of the device within the period of time, U represents the utilizable time of the device within the period of time, and M represents the quantity of products actually outputted by the device within the period of time.

For example, in the method according to embodiments of the present disclosure, the performance utilization is determined according to the following equation:

$$P = \frac{T}{A} = \frac{( Σ Tm * Mm ) \text{/} Σ Mm}{U \text{/} M} ,$$

where P represents the performance utilization of the device within the period of time.

For example, in the method according to embodiments of the present disclosure, prior to determining the average tact time of the device within the each of the sub periods of time for the N continuous sub periods of time within a continuous period of time, the method may further include: dividing the continuous period of time into the N continuous sub periods of time equally; or dividing the continuous period of time into the N continuous sub periods of time based on production of a same quantity of products.

For example, in the method according to embodiments of the present disclosure, the device is configured to produce display panels, and dividing the continuous period of time into the N continuous sub periods of time based on the production of the same quantity of products may include: dividing the continuous period of time into the N continuous sub periods of time based on production of a same quantity of display panels, wherein the quantity of display panels produced within each of the N continuous sub periods of time is a largest quantity of display panels that is capable of being accommodated by two clips, the clips being used to accommodate the display panels when the display panels are produced.

At least one embodiment according to the present disclosure provides a storage medium. The storage medium is stored with a computer executable instruction, and the computer executable instruction, upon being executed by a computer, causes the computer to execute the method mentioned above.

### BRIEF DESCRIPTION OF THE DRAWINGS

In order to describe technical solutions of embodiments of the present disclosure more clearly, accompanying drawings of the embodiments will be introduced simply. Obviously, the drawings described below only relate to some embodiments of the present disclosure, but not limit the present disclosure.

FIG. 1 is a flow diagram of a method for determining a performance utilization of a device provided in an embodiment of the present disclosure;

FIG. 2 is a schematic diagram of comparative analysis of a first mode and a second mode in an embodiment of the present disclosure;

FIG. 3 is a schematic diagram of comparison of a performance tact time of different devices in the case of a shorter sub period of time in an embodiment of the present disclosure;

FIG. 4 is a schematic diagram of comparative analysis of dividing a period of time by adopting different dividing basis in an embodiment of the present disclosure;

FIG. 5 is a schematic diagram of dividing a period of time when a device produces two types of products in an embodiment of the present disclosure;

FIG. 6 is a schematic diagram of correlation analysis between overall equipment effectiveness of a device and actual output of the device in an embodiment of the present disclosure.

### DETAILED DESCRIPTION

With respect to the problem existing in the prior art that it is very difficult to measure utilization of a device accurately, there is provided in embodiments of the present disclosure a method for determining a performance utilization of a device and a storage medium.

Specific implementations of the method for determining the performance utilization of the device and the storage medium provided in the embodiments of the present disclosure will be described in detail by combining with the accompanying drawings. Sizes and shapes of respective parts in the drawings do not reflect the real proportion, and just aim at illustrating the content of the embodiments of the present disclosure.

For example, time utilization (also referred to as time activation) can refer to a ratio of an actual processing time to an operable time of the device. For example, performance utilization (also referred to as performance activation) can refer to a ratio of a time the device operates at a designed speed to a time the device operates at a speed for actually producing a product. In general, the operation speed of the device is reflected in terms of tact time (TT). Generally, in calculation of performance utilization, a designed speed (for example, designed tact time) can be defined as a repeated maximum operating speed. However, the designed speed is a vague definition and is hard to be measured. In respective industries, measurement standards for the designed speed in respective factories are different. For example, some factories take an interval (Spec) for inspection of the device as the maximum speed, some factories take a time interval of products being capable of outputted at the historical maximum capacity as the maximum speed, and some factories take the shortest time interval of products outputted within one hour as the maximum speed. Furthermore, the designed speed of the same device for producing different models of products, or the designed speed for different processes of products varies greatly. In addition, the designed speed is likely to be affected by operating conditions. Therefore, in some cases, it is very difficult to measure utilization of the device, so that the operating conditions of the device cannot be determined accurately through the utilization, and comparison among utilizations of the factories cannot realized, either.

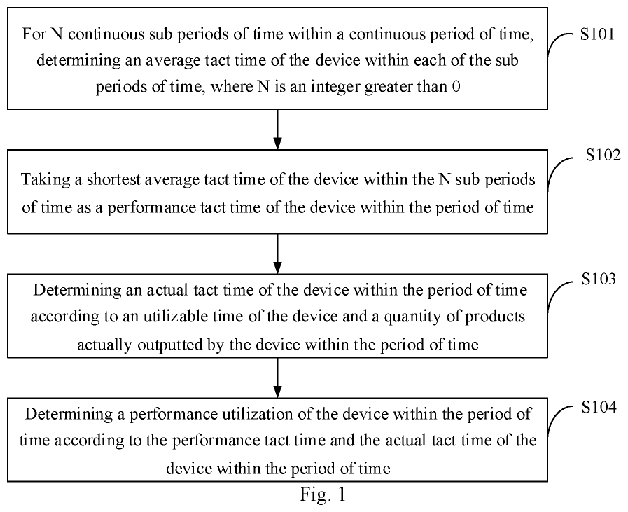

There is provided in at least one embodiment of the present disclosure a method for determining performance utilization of the device. FIG. 1 shows a flow diagram of a method for determining performance utilization of the device according to at least one embodiment of the present disclosure.

By referring to FIG. 1, in step S101, for N continuous sub periods of time within a continuous period of time, an average tact time of the device within each of the sub periods of time is determined, where N is an integer greater than 0.

By referring to FIG. 1, in step S102, a shortest average tact time of the device within the N continuous sub periods of time is taken as a performance tact time of the device within the continuous period of time.

By referring to FIG. 1, in step S103, an actual tact time of the device within the continuous period of time is determined according to an utilizable time of the device and a quantity of products actually outputted by the device within the continuous period of time. For example, the utilizable time may be a time spent on producing the product normally.

By referring to FIG. 1, in step S104, a performance utilization of the device within the continuous period of time is determined according to the performance tact time and actual tact time of the device within the continuous period of time.

The method provided in the embodiment of the present disclosure determines the performance utilization of the device by adopting the performance tact time. The performance tact time would not be affected under production of different models of products, different processes or operating conditions of the device. Furthermore, the method is capable of constantly updating the performance tact time according to the actual production condition and operating condition of the device. Thus, the method can avoid the case of failing to measure the utilization accurately from occurring due to vague definition or device stability change, and can also realize comparison among utilizations of factories.

For example, in embodiments of the present disclosure, the tact time can be understood as a time interval between two products (i.e., the product reaches the same position of the device) continuously produced by the device. For example, the tact time can also be understood as a time required for completing one piece of product by the device. Therefore, the tact time can indirectly reflect the operating speed of the device.

In order to avoid the performance utilization of the device from being difficult to be accurately determined due to the vague definition and avoid the production capacity of the device from being known well, in the embodiment of the present disclosure, the performance utilization is determined through the performance tact time. For example, the performance tact time can be understood as a production tact time which can be reached by the device theoretically. For example, the performance tact time may vary with the actual operating condition of the device, so that the operating status of the device can be reflected dynamically, which is advantageous for utilizing the device reasonably, and improving utilization ratio of the device.

In some embodiments, the step S101 can include: for N continuous sub periods of time within the continuous period of time, determining the average tact time of the device within each of the sub periods of time according to a time parameter of producing products by the device and a quantity of products outputted by the device within each of the sub period of time.

In embodiments of the present disclosure, the average tact time can refer to an average value of time intervals of every two products outputted within the continuous period of time. An example by taking the time of one day (i.e., continuous 24 hours) as a continuous period of time will be described, of which the period of time is divided equally into 4 continuous sub periods of time, that is to say, each of the sub periods of time is continuous 6 hours. In this example, in the step S101, the average tact time of the device within every 6 hours can be determined according to a time parameter of the device and a quantity of products outputted by the device within every 6 hours, through monitoring the production conditions of the device. In this example, in the step S102, the shortest performance tact time can be taken as the performance tact time by comparing the performance tact times within 4 periods of time. In this example, in the step S103, the actual tact time of the device within the period of time is determined according to the utilizable time (that is, the time spent on producing products normally) of the device and the quantity of products actually outputted by the device within the 24 hours. For example, the actual tact time can be understood as the time interval of two pieces of products continuously produced by the device in the actual production process. For example, if the normal operating time of the device within the 24 hours is 15 hours, and the quantity of products actually outputted is 100, then the actual tact time of the device within the 24 hours is 0.15 (hour/piece). In this example, in the step S104, the performance utilization can be determined according to the above determined performance tact time and the actual tact time.

It needs to note that although the above describes the example of dividing the period of time equally. However, the embodiment of the present disclosure is not limited thereto. Various modification can be made on such a basis.

In some embodiments, in the step S101, determining an average tact time of the device within each of the sub periods of time according to a time parameter of producing a product by the device and a quantity of products outputted by the device within each of the sub periods of time can be implemented in the following mode: taking the average value of interval times between every two pieces of products outputted by the device within each of the sub periods of time as the average tact time of the device within each of the sub periods of time. For the purpose of convenient description, this mode is called as “first mode”.

For example, within one sub period of time, the device produces four products A, B, C, and D. If the interval time of the product A and the product B outputted by the device is 50 minutes(min), the interval time of the product B and the product C outputted by the device is 45 min, and the interval time between the product C and the product D outputted by the device is 55 min, then the average tact time of the device within the sub period of time is 50 min. In some embodiments, an interval between starting times that the device produces two pieces of products can be taken as the time interval. For example, if the device starts producing the product A at 10:10 am and starts producing the product B at 11:00 am, then the interval time between the product A and the product B outputted by the device is 50 min. Alternatively, other time points can also be adopted as a reference point for determining the time interval, to which no limitations are made.

In some embodiments, in the step S101, determining the average tact time of the device within each of the sub periods of time according to a time parameter of producing a product by the device and a quantity of products outputted by the device within each of the sub periods of time can be implemented in the following mode: taking a ratio between the normal operation time of the device and the quantity of products outputted by the device within each of the sub periods of time as the average tact time of the device within each period of time. For the purpose of convenient description, this mode is referred to as “second mode”.

For example, within one sub period of time, time on not producing products normally such as downtime or maintenance is likely to occur to the device. Therefore, the normal operation time may refer to the operation time by removing the time on not producing products normally, and can be represented as Uptime. The ratio between Uptime and the quantity of products outputted by the device within the sub period of time can be taken as the average tact time.

For example, in some embodiments, prior to the step S101, it further includes: dividing the continuous period of time into the N continuous sub periods of time equally; or dividing the continuous period of time into the N continuous period of time based on production of a same quantity of products. For example, the time on producing two products can be taken as one sub period of time. That is to say, the period of time in step S101 can be divided into sub periods of time equally or can be divided into sub periods of time unequally only if the period of time is divided into continuous periods of time. For example, it can be determined adopting which kind of mode to divide the period of time according to the cycle that the device actually produces the products.

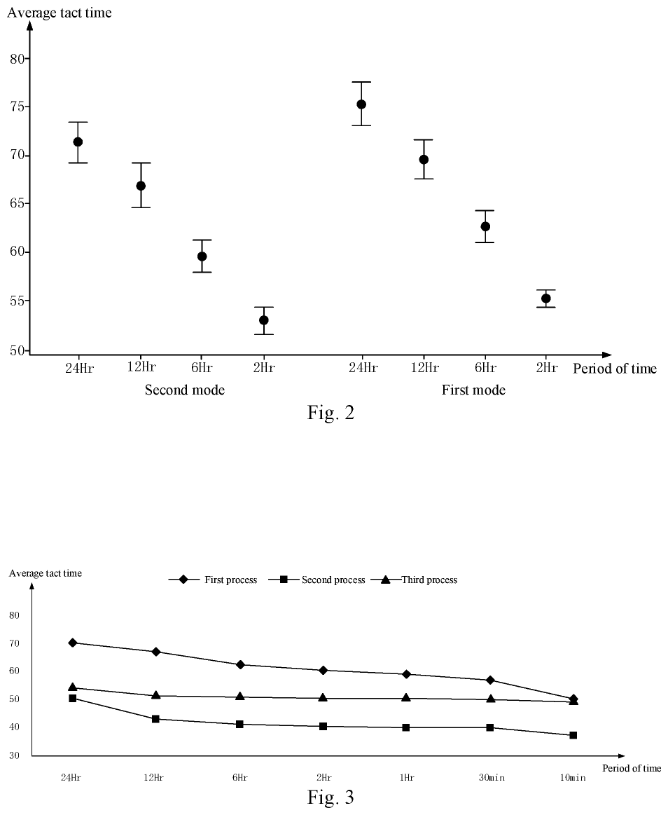

The first mode and the second mode are compared by combining with the accompanying drawings. FIG. 2 is a schematic diagram of comparison of average tact times of different continuous periods of time obtained by operating a photolithographic device for 15 days. The four data in the left side of FIG. 2 indicates the average tact times (seconds) obtained by adopting the second mode and taking the sub period of time as 24 hours(Hr), 12 Hr, 6 Hr and 2 Hr, the four data in the right side of FIG. 2 indicates the average tact times (seconds) obtained by adopting the first mode and taking the sub period of time as 24 Hr, 12 Hr, 6 Hr and 2 Hr, the lower horizontal line in each data in FIG. 2 indicates a minimum value of the average tact time, the upper horizontal line in FIG. 2 indicates a maximum value of the average tact time, and the black cycle indicates that approximately 95% values fall into the circle.

It can be seen from FIG. 2 that as for both the first mode and the second mode, the value of the average tact time is reduced as the sub period of time decreases. Furthermore, as the sub period of time decreases, the difference between the first mode and the second mode becomes smaller and smaller. The difference is that as the sub period of time decreases, the dispersibility of the value of the average tact time obtained by adopting the first mode becomes smaller and smaller. The reason of the above lies in that the shorter the sub period of time is, the easier the influence of the breakdown maintenance (BM) time and the preventive maintenance (PM) on the average tact time would be removed. Furthermore, when the sub period of time is shorter, the relationship (that is, the result of the second mode) between the normal operation time of the device and the quantity of products actually outputted by the device is easier to be affected by a basis of normal operation time of the device and a basis of the calculation of the output. Therefore, in some embodiments, the mode of the average tact time and the length of the sub period of time can be selected and determined according to a time cycle that the device produces products.

FIG. 3 is a schematic diagram of comparison of performance tact times of different devices in the case of the sub period of time being shorter, by adopting the same mode of determining the performance tact time. A curve formed by “♦” in the FIG. 3 represents a device configured to perform a first process, a curve formed by “▪” represents a device configured to perform a second process, and a curve formed by “▴” represents a device configured to perform a third process. For example, the first process may be a photo process, the second process may be a sputter process, and the third process may be a wet etch process. FIG. 3 is an average tact time (seconds) obtained when the device has operated continuously for 7 days and the sub periods of time are 24 Hr, 12 Hr, 6 Hr, 2 Hr, and 1 Hr, 30 minutes (min) and 10 min respectively. It can be seen from FIG. 3 that when the sub period of time is about 1 Hr, the average tact time of respective devices tends to be stable, but after the sub period of time is smaller than 1 Hr, the average tact time of respective devices would fluctuate greatly, for example, the average tact time of the device corresponding to the first process fluctuates maximally. For example, as for a photo process device configured to product display panels, the process time of the photo process device for respective display panels in one clip is different. In this case, it may not be able to complete the process of respective display panels in the whole clip by adopting a sub period of time of 10 min, and thus other sub periods of time can be selected. Therefore, in some implementations, the length of the sub period of time can be selected reasonably according to the time spent by the device on producing one piece of product.

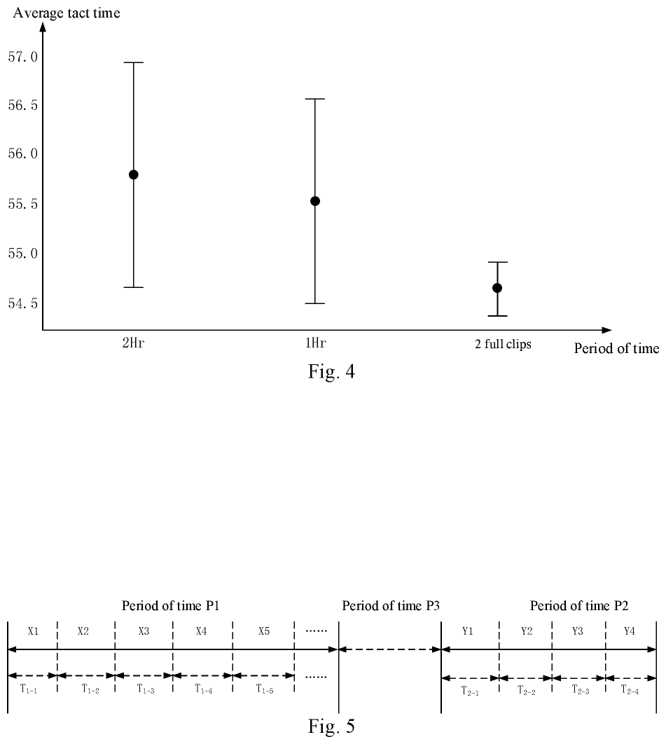

In some embodiments, if the average tact time obtained by adopting the mode of dividing the period of time equally is dispersed or fluctuated greatly, the period of time can also be divided into N sub periods of time based on production of the same quantity of products. For example, in the case of using a clip to accommodate outputted products, the quantity of products produced within one sub period of time can be a maximum quantity of products being capable of being accommodated by two clips. For example, when the device is used to produce display panels, the quantity of products produced within one sub period of time can be a maximum quantity of display panels being capable of being accommodated by two clips. For the purpose of convenient description, the maximum quantity of products (for example, display panels) being capable of being accommodated by the clip is called as full clip. For example, the maximum quantity of products being capable of being accommodated by two clips is called as two full clips. FIG. 4 is a schematic diagram of comparison of average tact times (seconds) obtained when the photo device has operated for 6 days by taking 2 Hr, 1 Hr and production of two full clips of display panels as a dividing basis. It can be seen from FIG. 4 that the distribution range of the average tact time obtained by taking two full clips of display panels as a dividing basis is more intensive than that obtained by taking 2 Hr and 1 Hr as a dividing basis. Therefore, as for the photo process device, the period of time can be divided based on production of two full clips of display panels. For example, the time on producing two full clips of display panels can be taken as a length of respective sub periods of time. In some embodiments, production of other quantities of products can also be adopted as a dividing basis, to which no limitation is made.

In some implementations, when the difference of the process in producing different types of products by the device is great, calculating the performance of the whole day based on the shortest interval time of outputting products would cause that the actual performance of the device is lower than the performance reflected from the utilization obtained by the above method. Therefore, factors of device types, processes, product models of the device can be taken into consideration. For example, the above method of determining the performance utilization can be optimized by means of setting a weight.

In some embodiments, the device produces at least two types of products. In this case, in the step S101, determining the average tact time of the device within each of the sub periods of time according to the time parameter of producing products by the device and a quantity of products outputted by the device within each of the sub periods of time comprises: for each type of product, determining the average tact time of the device within respective sub periods of time corresponding to the product according to the time parameter of producing the product by the device and the quantity of products outputted by the device within the respective sub periods of time corresponding to the product. In this case, the step S102 comprises: for each type of product, determining the shortest average tact time of the device within respective periods of time corresponding to the product, and taking a weighted average value of shortest average tact times of the device corresponding to various types of products as the performance tact time of the device within the period of time.

In some embodiments of the present disclosure, with respect to each type of product, by determining the average tact time of the device within the respective sub periods of time corresponding to the product respectively, and then determining the shortest average tact time within the respective sub periods of time corresponding to each type of product, a weighted average value of the shortest average tact time corresponding to respective products is taken as the performance tact time of the device within the period of time. That is to say, the performance tact time of each type of product is firstly determined, and then the performance tact times of respective products are weighted and averaged to obtain the performance tact time of the device within the period of time. Through this method, the influence of abnormal operation time such as device downtime and maintenance can be removed, and thus it is capable of reflecting the optimal operation speed of the device in a better way.

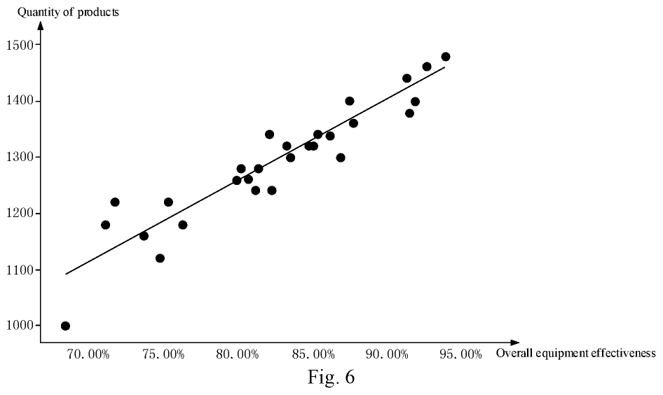

As shown in FIG. 5, by taking the device producing two types of products, i.e., the first product and the second product as an example, a period of time P1 in FIG. 5 represents a time that the device produces the first product, a period of time P2 represents a time that the device produces the second product, and a period of time P3 represents a time that the device operates abnormally, such as downtime or maintenance time. Furthermore, the period of time P1 and the period of time P2 are divided into a plurality of sub periods of time by taking the time of two full clips as a dividing basis. As shown in FIG. 5, the period of time P1 is divided into sub periods of time X1, X2, X3, X4, X5, etc. That is to say, any one of the periods of time X1, X2, X3, X4, X5 etc. represents the time on producing two full clips of products. Similarly, the period of time P2 is divided into sub periods of time Y1, Y2, Y3 and Y4, of which any one of Y1 to Y4 represents the time on producing two full clips of products.

The average tact time of the device within respective sub periods of time can be determined by adopting the first mode and the second mode. As shown in FIG. 5, an average tact time of respective periods of time of the device within the period of time P1 is T₁₋₁, T₁₋₂, T₁₋₃, T₁₋₄, T₁₋₅, etc., and an average tact time of respective periods of time of the device within the period of time P2 is T₂₋₁, T₂₋₂, T₂₋₃, T₂₋₄, etc. The shortest average tact time of respective periods of time of the device within the period of time P1 is taken as the performance tact time. That is to say, the performance tact time of the device within the period of time P1 is min (T₁₋₁, T₁₋₂, T₁₋₃, T₁₋₄, T₁₋₅. . . )=T1. Similarly, the performance tact time of the device within the period of time P2 is min (T₂₋₁,l T₂₋₂, T₂₋₃, T₂₋₄)=T2. Finally, the performance tact time of the device within the period of time P1 and the performance tact time of the device within the period of time P2 are weighted and averaged. For example, outputs of the device within respective periods of time are weighted and averaged, to obtain the performance tact time of the device within the periods of time P1, P2, and P3. By taking an output of the device within the period of time P1 being M1 and an output of the device within the period of time P2 being M2 as an example, the performance tact of the device within the periods of time P1, P2 and P3 is (T1×M1+T2×M2)/(M1+M2).

For example, in some embodiments, the above performance tact time is determined according to the following equation:

$$T = \frac{Σ Tm * Mm}{Σ Mm} ,$$

where T represents the performance tact time of the device within the period of time, Tm represents the shortest average tact time among average tact times within respective sub periods of time corresponding to a m-th type of product produced by the device, and Mm represents a quantity of the m-th type of products produced by the device within the period of time. Since the performance tact time obtained from this equation is weighted and averaged according to the output of each type of product, it can reflect production capacity of the device in different production processes or different products, so as to measure the whole operating speed of the device.

For example, in some embodiments, the above actual tact time is determined according to the following equation:

$$A = \frac{U}{M} ,$$

where A represents the actual tact time of the device within the period of time, U represents an utilizable time of the device within the period of time, M represents a quantity of products actually outputted by the device within the period of time.

For example, in some embodiments, the equation of the performance utilization can be obtained according to the above equations of the performance tact time and the actual tact time, i.e., the performance utilization is determined according to the following equation:

$$P = \frac{T}{A} = \frac{( Σ Tm * Mm ) \text{/} Σ Mm}{U \text{/} M} ,$$

where P represents the performance utilization of the device within the period of time. Since no vague parameter exists in this equation, the utilization of the device can be measured accurately. Furthermore, this equation can measure the production capacity of the device dynamically, so as to guide the actual production according to the performance utilization determined according to the equation and improve the production efficiency.

For example, in some embodiments, the above device can be configured to produce display panels. In this case, dividing a continuous period of time into N continuous sub periods of time based on production of a same quantity of products comprises: dividing the continuous period of time into the N continuous periods of time based on production of two full clips of display panels. That is to say, within a continuous period of time, a time on producing two full clips of display panels is determined as one sub period of time. In addition, a time on producing other quantity of display panels can also be adopted as a dividing basis, to which no limitation is made herein.

In order to further prove the effectiveness of the method provided in the embodiment of the present disclosure, embodiments of the present disclosure make a correlation analysis by using overall equipment effectiveness (OEE) data and the actual output of the device within one consecutive month, of which the overall equipment effectiveness is a product of the time utilization, the performance utilization and the yield rate. Therefore, the effectiveness of the overall equipment effectiveness can indirectly reflect the effectiveness of the performance utilization. As shown in FIG. 6, it can be obtained that it is a linear relationship between the overall equipment effectiveness of the device and the quantity of products actually produced by the device (actual output), for example, the linear relationship can be represented as M=100.3+1448OEE, where M represents the quantity of products actually outputted by the device, OEE represents the overall equipment effectiveness. A correlation analysis is made by adopting a linear regressive model based on the linear relationship. In a correlation analysis result, the value of R-Sq may reach 84%, of which the value of R-Sq indicates a ratio of linear regressive model errors to total errors. Since the value of R-Sq is greater than 80%, it shows that the effectiveness of the linear regressive model based on the above linear relationship is high. Therefore, it can be described that the overall equipment effectiveness of the performance utilization determined based on methods provided in embodiments of the present disclosure can efficiently reflect the actual output of the device, that is, the production capacity of the device can be reflected truly.

There is further provided in at least one embodiment of the present disclosure a storage medium. The above storage medium is stored with a computer executable instruction, which is used to cause a computer to execute methods according to various embodiments of the disclosure.

For example, the above storage medium can be any available medium or data storage device that is capable of accessed and stored by the computer, including but not limited to a magnetic memory (such as soft disk, hard disk, magnetic tape, magneto optical disc (MO Disc), etc.), an optical memory (such as compact Disk (CD), Digital Video Disc (DVD), Blu-ray Disc (BD), High-definition Versatile Disc (HVD), etc.), and a semiconductor memory (such as Read-Only Memory (ROM), Erasable Programmable Read Only Memory (EPROM), Electrically Erasable Programmable read only memory (EEPROM), a non-volatile memory (such as NAND FLASH), a solid state drive (SSD)), etc.

There is provided in embodiments of the present disclosure a method for determining a performance utilization of the device and a storage medium. The method may include: for N continuous sub periods of time within a continuous period of time, determining an average tact time of the device within each of the sub periods of time, where N is an integer greater than 0; taking a shortest average tact time of the device within the N sub periods of time as a performance tact time of the device within the period of time; determining an actual tact time of the device within the period of time according to an utilizable time of the device and a quantity of products actually outputted by the device within the period of time; and determining a performance utilization of the device within the period of time according to the performance tact time and the actual tact time of the device within the period of time. The above method for determining the performance utilization of the device and the storage medium provided in embodiments of the present disclosure determine the performance utilization of the device by adopting the performance tact time which would not be influenced by different product models produced by the device, different processes or operating conditions, and is capable of constantly updating the performance tact time according to the actual production condition and the operating condition of the device, which can avoid from failing to measure the utilization accurately due to vague concepts or change of device stability, and can realize comparison of utilizations among the factories. In addition, the method for determining the performance tact time of the device in the case of different processes product or different product models is considered, and thus this method can constantly update the performance tact time according to the actual output condition of the production line and the operating condition of the device, which avoids from failure of performance comparison of the device because the device cannot be updated timely due to vague concepts and stability promotion.

The above descriptions are just illustrative implementations of the present disclosure, but are not used to limit the protection scope of the present disclosure. The protection scope of the present disclosure is defined by the claims and the equivalents thereof.

What is claimed is:

1. A method for determining performance utilization of a device, comprising:
for N continuous sub periods of time within a continuous period of time, determining an average tact time of the device within each of the sub periods of time, where N is an integer greater than 0;
taking a shortest average tact time of the device within the N sub periods of time as a performance tact time of the device within the period of time;
determining an actual tact time of the device within the period of time according to an utilizable time of the device and a quantity of products actually outputted by the device within the period of time; and
determining a performance utilization of the device within the period of time according to the performance tact time and the actual tact time of the device within the period of time.

2. The method according to claim 1, wherein for the N continuous sub periods of time within the continuous period of time, determining the average tact time of the device within the each of the sub periods of time comprises:
taking an average value of interval times between every two products outputted by the device within the each of the sub periods of time as the average tact time of the device within the each of the sub periods of time.

3. The method according to claim 1, wherein for the N continuous sub periods of time within the continuous period of time, determining the average tact time of the device within the each of the sub periods of time comprises:
for N continuous sub periods of time within a continuous period of time, determining an average tact time of the device within the each of the sub periods of time according to a time parameter of producing products by the device and a quantity of products outputted by the device within the each of the sub periods of time.

4. The method according to claim 3, wherein determining the average tact time of the device within the each of the sub periods of time according to the time parameter of producing the products by the device and the quantity of products outputted by the device within the each of the sub periods of time comprises:
taking a ratio between a normal operation time of the device and the quantity of products outputted by the device within the each of the sub periods of time as the average tact time of the device within the each of the sub periods of time.

5. The method according to claim 3, wherein the device is configured to produce at least two types of products,
wherein determining the average tact time of the device within the each of the sub periods of time according to the time parameter of producing the products by the device and the quantity of products outputted by the device within the each of the sub periods of time comprises:
for each type of product, determining the average tact time of the device within respective sub periods of time corresponding to the product according to the time parameter of producing the products by the device and the quantity of products outputted by the device within respective sub periods of time corresponding to the product, and
wherein taking the shortest average tact time of the device within the N sub periods of time as the performance tact time of the device within the period of time comprises:
for each type of product, determining the shortest average tact time of the device within respective sub periods of time corresponding to the product, and
taking a weighted average value of shortest average tact times of the device corresponding to various types of products as the performance tact time of the device within the period of time.

6. The method according to claim 5, wherein the performance tact time is determined according to the following equation:
$$T = \frac{Σ Tm * Mm}{Σ Mm} ,$$
where T represents the performance tact time of the device within the period of time, Tm represents the shortest average tact time within respective sub periods of time corresponding to m-th type of products produced by the device, and Mm represents a quantity of the m-th type of products outputted by the device within the period of time.

7. The method according to claim 6, wherein the actual tact time is determined according to the following equation:
$$A = \frac{U}{M} ,$$
where A represents the actual tact time of the device within the period of time, U represents the utilizable time of the device within the period of time, and M represents the quantity of products actually outputted by the device within the period of time.

8. The method according to claim 7, wherein the performance utilization is determined according to the following equation:
$$P = \frac{T}{A} = \frac{( Σ Tm * Mm ) \text{/} Σ Mm}{U \text{/} M} ,$$
where P represents the performance utilization of the device within the period of time.

9. The method according to claim 1, wherein prior to determining the average tact time of the device within the each of the sub periods of time for the N continuous sub periods of time within the continuous period of time, the method further comprises:
dividing the continuous period of time into the N continuous sub periods of time equally; or
dividing the continuous period of time into the N continuous sub periods of time based on production of a same quantity of products.

10. The method according to claim 9, wherein the device is configured to produce display panels, and
wherein dividing the continuous period of time into the N continuous sub periods of time based on the production of the same quantity of products comprises:
dividing the continuous period of time into the N continuous sub periods of time based on production of a same quantity of display panels, wherein the quantity of display panels produced within each of the N continuous sub periods of time is a largest quantity of display panels that is capable of being accommodated by two clips, the clips being used to accommodate the display panels when the display panels are produced.

11. A storage medium which is stored with a computer executable instruction, wherein the computer executable instruction, upon being executed by a computer, causes the computer to execute operations comprising:
for N continuous sub periods of time within a continuous period of time, determining an average tact time of the device within each of the sub periods of time, where N is an integer greater than 0;
taking a shortest average tact time of the device within the N sub periods of time as a performance tact time of the device within the period of time;
determining an actual tact time of the device within the period of time according to an utilizable time of the device and a quantity of products actually outputted by the device within the period of time; and
determining a performance utilization of the device within the period of time according to the performance tact time and the actual tact time of the device within the period of time.

12. The storage medium according to claim 11, wherein for the N continuous sub periods of time within the continuous period of time, an operation of determining the average tact time of the device within the each of the sub periods of time comprises:
taking an average value of interval times between every two products outputted by the device within the each of the sub periods of time as the average tact time of the device within the each of the sub periods of time.

13. The storage medium according to claim 11, wherein for the N continuous sub periods of time within the continuous period of time, an operation of determining the average tact time of the device within the each of the sub periods of time comprises:
for the N continuous sub periods of time within the continuous period of time, determining the average tact time of the device within the each of the sub periods of time according to a time parameter of producing products by the device and a quantity of products outputted by the device within the each of the sub periods of time.

14. The storage medium according to claim 13, wherein an operation of determining the average tact time of the device within the each of the sub periods of time according to the time parameter of producing the products by the device and a quantity of products outputted by the device within the each of the sub periods of time comprises:
taking a ratio between a normal operation time of the device and the quantity of products outputted by the device within the each of the sub periods time as the average tact time of the device within each period of time.

15. The storage medium according to claim 13, wherein the device is configured to produce at least two types of products,
wherein an operation of determining the average tact time of the device within the each of the sub periods of time according to the time parameter of producing products by the device and a quantity of products outputted by the device within the each of the sub periods of time comprises:
for each type of product, determining the average tact time of the device within respective sub periods of time corresponding to the product according to the time parameter of producing products by the device and a quantity of products outputted by the device within respective sub periods of time corresponding to the product, and
wherein an operation of taking the shortest average tact time of the device within the N sub periods of time as the performance tact time of the device within the period of time comprises:
for each type of product, determining the shortest average tact time of the device within respective sub periods of time corresponding to the product, and
taking a weighted average value of shortest average tact times of the device corresponding to various types of products as the performance tact time of the device within the period of time.

16. The storage medium according to claim 15, wherein the performance tact time is determined according to following equation:
$$T = \frac{Σ Tm * Mm}{Σ Mm} ,$$
where T represents the performance tact time of the device within the period of time, Tm represents the shortest average tact time within respective sub periods of time corresponding to m-th type of products produced by the device, and Mm represents a quantity of the m-th type of products outputted by the device within the period of time.

17. The storage medium according to claim 16, wherein the actual tact time is determined according to the following equation:
$$A = \frac{U}{M} ,$$
where A represents the actual tact time of the device within the period of time, U represents the utilizable time of the device within the period of time, and M represents the quantity of products actually outputted by the device within the period of time.

18. The storage medium according to claim 17, wherein the performance utilization is determined according to the following equation:
$$P = \frac{T}{A} = \frac{( Σ Tm * Mm ) \text{/} Σ Mm}{U \text{/} M} ,$$
where P represents the performance utilization of the device within the period of time.

19. The storage medium according to claim 11, wherein prior to the operation of determining the average tact time of the device within the each of the sub periods of time for the N continuous sub periods of time within the continuous period of time, the operations further comprise:
dividing the continuous period of time into the N continuous sub periods of time equally; or
dividing the continuous period of time into the N continuous sub periods of time based on production of a same quantity of products.

20. The storage medium according to claim 19, wherein the device is configured to produce display panels;
the operation of dividing the continuous period of time into the N continuous sub periods of time based on the production of the same quantity of products comprises:
dividing the continuous period of time into the N continuous sub periods of time based on production of a same quantity of display panels, wherein the quantity of display panels produced within each of the N continuous sub periods of time is a largest quantity of display panels that is capable of being accommodated by two clips, the clips being used to accommodate the display panel when the display panels are produced.
